(19) United States
(12) Patent Application Publication
(10) Pub. No.: US 2013/0140221 A1
(43) Pub. Date: Jun. 6, 2013

(54) DEVICE FOR SEPERATING CARDBOARD COMPONENTS

(71) Applicant: Udo Grumbach, Harsewinkel (DE)

(72) Inventor: Udo Grumbach, Harsewinkel (DE)

(73) Assignee: Grumbach GmbH & Co. KG, Harsewinkel (DE)

(21) Appl. No.: 13/311,642

(22) Filed: Dec. 6, 2011

(51) Int. Cl. B07B 13/00

(52) U.S. Cl. 209/688

(57) ABSTRACT

A device for separating cardboard components from bulk waste paper features a sorting unit that includes a feed area (1) including a flexibly mounted support (5) on which the bulk waste paper is supplied to a receiving device (3) studded with spikes (2). The spikes (2) and the feed area (1) are designed such that the spikes (2) essentially skewer only the cardboard components of the bulk waste paper fed in the feed area (1) while any material that cannot be skewered may cause the support (5) to move downwardly upon application of a specified force and bypass the spikes (2). At least one of the spikes (2) is connected to a receiving device (3) such that it can be displaced when a prespecified force is encountered.

### TECHNICAL FIELD

The invention relates to a device for separating cardboard components from bulk waste paper and more particularly, to such a device having a support in the feed area that can deflect under predetermined pressure and one or more spikes that can also deflect under pressure.

### BACKGROUND INFORMATION

A similar device is known from EP 1 291 092 B1, for example. The known device includes a roller having spikes arranged on its circumference. The bulk waste paper is fed to the device on a support element that exhibits free spaces into which the spikes can dip. When paper arrives in the area between spike and recess, the paper yields into the recess and is not picked up by the spike. More rigid material such as cardboard, however, is not pressed into a respective recess but is pierced by the spike and taken along by the roller. The material adhering to the spikes is then separated from the roller by a stripper.

In practical applications, it is possible for other objects to enter the bulk waste paper when waste paper is disposed. In particular when hard objects such as wood enter a sorting device using said method, the result is that the spikes break off from the roller or become damaged.

It is therefore the object of the invention to provide a device of the type mentioned above, where breaking off or damaging of the spikes can be avoided in such situations.

### SUMMARY

The invention discloses a device for separating cardboard components from bulk waste paper. A sorting unit includes a feeding area on which the bulk waste paper is fed to a receiving device equipped with spikes. The feeding area is designed such that the spikes essentially skewer only the cardboard components of the bulk waste paper fed into the feeding area. At least one of the spikes is connected to the receiving device such that it can be displaced upon application of a pre-specified force.

According to the invention, the spikes are flexible and/or are connected to the receiving device. If an object that is located in the bulk waste paper enters into the receiving device and can neither be deformed or displaced nor skewered by the spikes, then the spikes can yield upon contact with said object without being damaged due to their flexible connection. For this purpose, in addition to the spikes, the receiving device preferably exhibits protrusions that, contrary to the spikes, are rigid and not flexible, such that the spikes between the protrusions are protected by the protrusions upon contact with a hard object and thus cannot break off.

Further, the support on which the bulk waste paper is conveyed to the receiving device and on which the sorted cardboard components are picked up is preferably provided in a flexible design as well. A large object may for example pass under the receiving device due to a yielding of the support, without this object blocking the equipment or becoming wedged between the receiving device and the support.

### BRIEF DESCRIPTION OF THE DRAWINGS

These and other features and advantages of the present invention will be better understood by reading the following detailed description, taken together with the drawings where in:

FIG. 1 shows a perspective view of a device according to the invention;

FIG. 1A shows an enlarged detail of the view of FIG. 1;

FIG. 2 shows a corresponding side view of the device according to the invention;

FIG. 2A shows an enlarged detail of FIG. 2;

FIG. 3A shows an enlarged detail of a section of the receiving device with spikes in a first position; and

FIG. 3B shows an enlarged detail of a section of the receiving device with spikes in a second position.

### DETAILED DESCRIPTION OF THE PREFERRED EMBODIMENTS

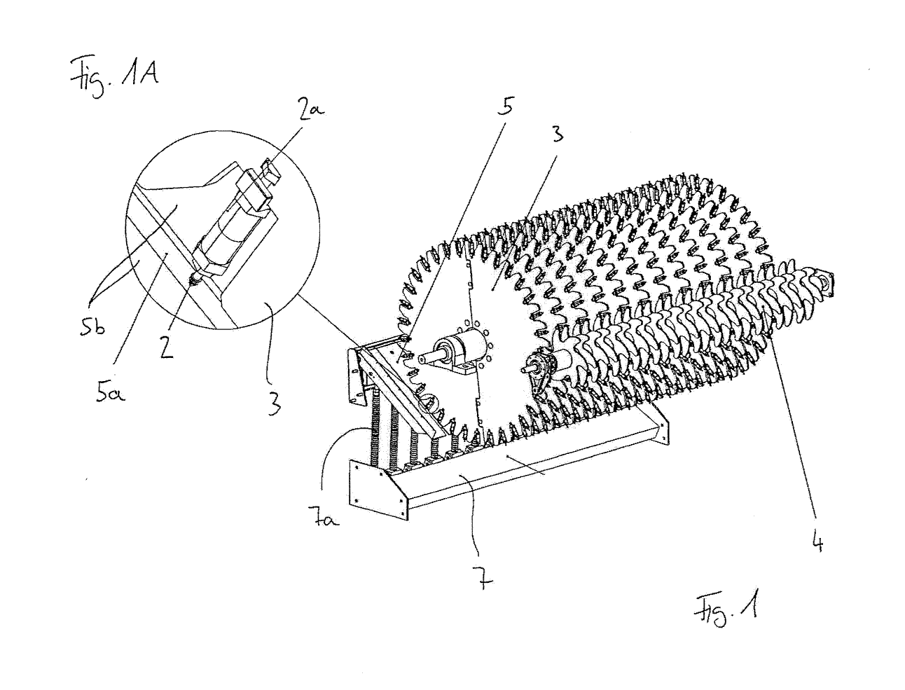

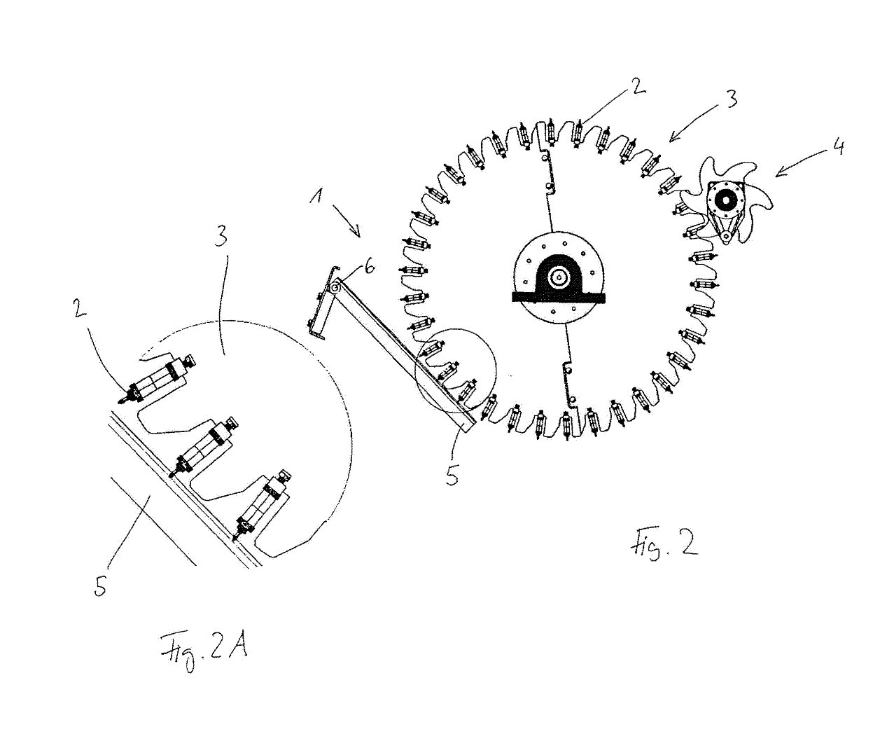

The device shown in FIGS. 1 and 1A or 2 and 2A, respectively, for separating cardboard components from bulk waste paper exhibits a sorting unit, which includes a feeding area 1 and a receiving device 2. At least one but preferably a plurality of disk-shaped receiving elements 3 serve as the receiving device. These, at their circumference, have radially protruding spikes 2 for skewering the cardboard components. In the example shown, the receiving elements 3 are supported rotatably parallel to each other and perpendicular to the feed direction of the bulk waste paper around a common rotational axis and form a roller-like receiving device. A stripping device 4 downstream serves the purpose of removing the skewered cardboard components from the roller 3.

According to the invention, the feeding area 1 is formed of a support 5, which can be comprised of one or more support elements 5b. Located in the support 5 are recesses 5a or depressions, into which the spikes 2 of the rotating receiving device 3 can dip, as is shown in FIG. 1A, for example. According to the invention, the support 5 is designed in such a way that it yields or deflects when a pre-specified amount of force acts upon it. Preferably, the force required for yielding is adjustable. In the example shown, a spring bar 7 with springs 7a attached to it is provided, said springs being compressed onto the support 5 at a pre-specified force thus generating an elastic restoring force, which pushes the support back to its original position when the acting force is reduced. The force to be preset for the springs 7a should be dimensioned such that the support 5 yields only little or not at all during “normal” operation, i.e., when skewering cardboard or pulling along paper. The flexibility of the support 5 has the effect that hard and especially thick objects that enter into bulk waste paper do not wedge between the support and the roller or damage components of the device. Instead, in this case the support 5 expands or moves downwards and the respective object can run through the system. The support 5 then springs back and no interruption of the running operation is required.

The support 5 is preferably designed in the form of a slide sloped downward toward the receiving device 3, as shown in particular in FIGS. 1 and 2. The support, or the support elements 5, respectively, of the feeding device are supported in a pivoting manner around an axis 6 at the side pointing away from the receiving device 3, such that the support 5 in the case described above pivots away from the receiving device in the event that thick or non-skewerable objects such as pieces of wood or catalogs or the like are supplied, allowing these objects to run through the system without the need to power down the system or without causing an operational stop.

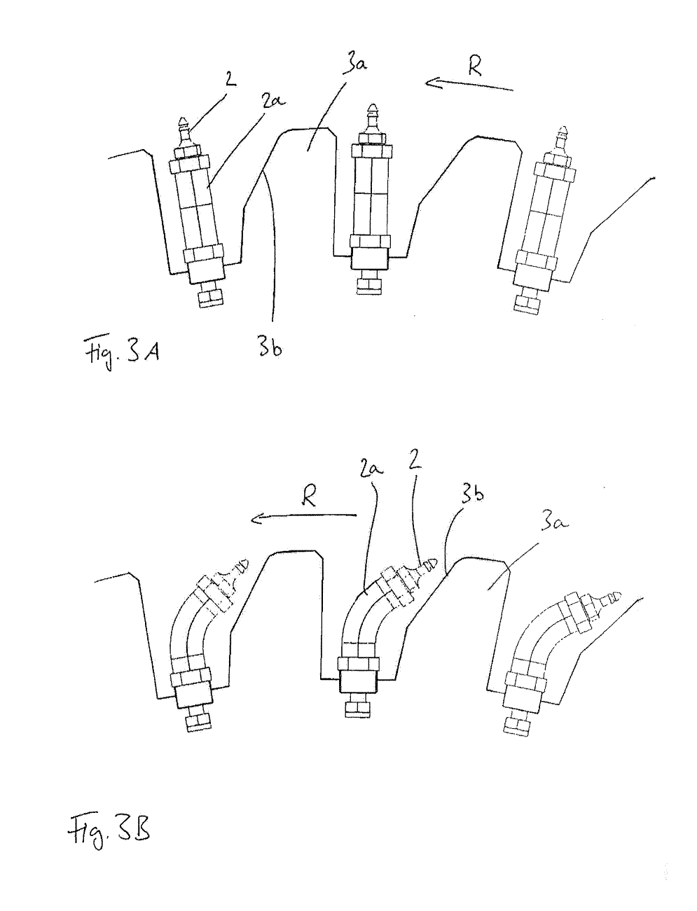

To prevent the spikes 2 from breaking in the situations mentioned, they are protected according to the invention by being attached to the receiving device such that they can avoid the effect of the force, for example when they contact an object that cannot be skewered. To this end, the spikes 2 are connected flexibly to the receiving device 3 as shown in FIGS. 3A and 3B. Flexible means that when a force is encountered, the spikes can move from a regular position shown in FIG. 3A into an avoidance position shown in FIG. 3B. For this purpose, the spike 2 can be attached to the receiving device via a connection element 2a that is flexible in this sense (e.g., made of rubber, another flexible material or in the form of a spring or in the form of a joint or the like). In addition to the spikes 2, protrusions 3a that have a protective function are provided between the spikes 2. In the regular position of the spikes 2 shown in FIG. 3A, the tips of said spikes extend beyond the outer edge of the adjacent protrusions 3a. The magnification of the detail shown in FIGS. 3A and 3B shows one exemplary embodiment in which the receiving device 3 is made of rotatably supported disk-shaped elements; the arrow R indicates the direction of rotation of the receiving roller 3.

If in the course of system operation a spike 2 now contacts a non-skewerable object, the spike will be displaced flexibly due to the effects of the force and on account of the flexible connection, which is shown in FIG. 3B. For this purpose, the protrusions exhibit a displacement space into which the spike can dip when a force is encountered. Preferably, the protrusions are chamfered or provided with recesses for this purpose. In the shown example, the side of the protrusion 3a that is running ahead in the direction of rotation R is chamfered. The displacement space is dimensioned such that the spike with its tip is located fully between adjacent protrusions 3a and no longer extends beyond the protrusions as is the case in the regular position shown in FIG. 3. As a result, the spike 2 is protected and when the receiving device 3 contacts a hard or not skewerable object, it essentially comes in contact only with the protrusions 3a. However, the protrusions are essentially built much stronger such that they are not damaged by said object. If a flexible support is provided as described above (which is not obligatory), then the receiving device 3 will press against the respective object via the protrusions, which in turn causes a force to be applied on the support, which will yield eventually, such that the non-skewerable object can pass through the device without damaging the spikes 2. Preferably, the connection element 2a for the spikes 2 is designed elastically such that the spikes 2 will return to their regular position after the displacement due to the effects of the force.

Modifications and substitutions by one of ordinary skill in the art are considered to be within the scope of the present invention, which is not to be limited except by the allowed claims and their legal equivalents.

1. A device for separating cardboard components from bulk waste paper, having a sorting unit which includes a feeding area (1), on which the bulk waste paper is fed to a receiving device (3) equipped with spikes (2) and the feeding area (1) is designed such that the spikes (2) essentially skewer only the cardboard components of the bulk waste paper fed into the feeding area (1),
characterized in that
at least one of the spikes (2) is connected to the receiving device (3) such that it can be displaced upon application of a prespecified force.

2. A device as set forth in claim 1,
characterized in that
a connection element (2a) is provided for connecting purposes, where said connection element (2a) is designed such that it is essentially rigid when a force is applied in the longitudinal direction of the spike (2) and essentially flexible if the force is applied in other directions.

3. A device as set forth in claim 1 or 2,
characterized in that
the feeding area (1) exhibits a support (5) on which the bulk waste paper can be fed to the receiving device (3) and that is designed such that the spikes (2) can penetrate the support (5) at least in part and/or that the support (5) yields upon pressure.

4. A device as set forth in claim 3,
characterized in that
the support exhibits a plurality of support elements (5) that are essentially arranged parallel and perpendicular to the feed direction of the bulk waste paper with said elements being supported such that they are displaced upon pressure.

5. A device as set forth in one of the claim 3 or 4,
characterized in that
the support or the support elements (5) is/are supported in a pivoting manner.

6. A device as set forth in claim 5,
characterized in that
the pivoting support is provided at the end of the support or support elements (5) that points away from the receiving device (3).

7. A device as set forth in one of the claims 3 to 6,
characterized in that
the support or the support elements (5) are designed such that they spring back when the pressure subsides.

8. A device as set forth in one of the previous claims,
characterized in that
the receiving device exhibits at least one receiving element with spikes arranged on its circumference.

9. A device as set forth in claim 8,
characterized in that
protrusions (3a) are arranged between adjacent spikes (2) on the circumference of the receiving element.

10. A device as set forth in claim 8,
characterized in that
the spikes (2) protrude in relation to the protrusions (3a) of the receiving element.

11. A device as set forth in claim 8 or 9,
characterized in that
the protrusions (3a) are designed such that on at least one side the spike (2) can be displaced at a prespecified application of force so that due to the flexible connection the respective concerned spike (2) can be fully pushed behind an adjacent protrusions.

12. A device as set forth in one of the claims 8 to 10,
characterized in that the protrusions (3a) are chamfered for the purpose of creating a displacement space for the spikes (2).

13. A device as set forth in one of the claims 8 to 12,
characterized in that
at least one disk element (3) is provided that is supported in a rotatable manner perpendicular to the feed direction.
